(19) United States
(12) Patent Application Publication
(10) Pub. No.: US 2024/0147152 A1
(43) Pub. Date: May 2, 2024

(54) Sound Processing Method, Sound Processing System, and Recording Medium

(71) Applicant: Yamaha Corporation, Hamamatsu-shi (JP)

(72) Inventor: Kenji ISHIZUKA, Hamamatsu-shi (JP)

(21) Appl. No.: 18/392,325

(22) Filed: Dec. 21, 2023

Related U.S. Application Data
(63) Continuation of application No. PCT/JP22/25788, filed on Jun. 28, 2022.

(30) Foreign Application Priority Data
Jun. 28, 2021 (JP) 2021-106453

(51) Int. Cl. H04R 3/02

(52) U.S. Cl. CPC H04R 3/02

(57) ABSTRACT

A computer-implemented sound processing method includes: acquiring a first audio signal representative of sound received by a sound receiving device; and generating a second audio signal by rotating a phase of the first audio signal in one direction over time in conjunction with receipt of the sound.

### CROSS REFERENCE TO RELATED APPLICATIONS

This application is a Continuation Application of PCT Application No. PCT/JP2022/025788 filed on Jun. 28, 2022, and is based on and claims priority from Japanese Patent Application No. 2021-106453 filed on Jun. 28, 2021, the entire contents of each of which are incorporated herein by reference.

### BACKGROUND

### Field of the Invention

This disclosure relates to audio signal processing.

Proposed in the art is suppression of howling in an audio system that includes a sound receiving device and a sound emitting device. For example, Patent Literature 1 (Japanese Patent Application Laid-Open Publication No. 2013-138329) discloses suppression of howling by use of a notch filter, whereby audio components within a rejection band of an audio signal are suppressed. The audio signal is analyzed to estimate a frequency that will cause howling (hereinafter, “howling frequency”), and a frequency band that includes the estimated frequency is set as a rejection band for the notch filter. Patent Literature 2 (Japanese Patent Application Laid-Open Publication No. 2012-124826) discloses suppression of howling by varying a pitch of an audio signal.

In the technique disclosed in Patent Literature 1 it is necessary to analyze an audio signal to identify a howling frequency. This technique is challenging since it requires a complex configuration and complex processing to suppress howling.

### SUMMARY

In view of the circumstances described above, an object of one aspect of this disclosure is to suppress howling without need to identify a howling frequency and without causing variation in audibly perceptible characteristics (e.g., pitches) of an audio signal.

To achieve the above-stated object, a computer-implemented sound processing method according to one aspect of this disclosure includes: acquiring a first audio signal representative of sound received by a sound receiving device; and generating a second audio signal by rotating a phase of the first audio signal in one direction over time in conjunction with receipt of the sound.

A sound processing system according to one aspect of this disclosure includes at least one memory that stores instructions; and at least one processor configured to implement the instructions to: acquire a first audio signal representative of sound received by a sound receiving device; and generate a second audio signal by rotating a phase of the first audio signal in one direction over time in conjunction with receipt of the sound.

A recording medium according to one aspect of this disclosure is a non-transitory computer-readable recording medium storing instructions executable to perform operations including: acquiring a first audio signal representative of sound received by a sound receiving device; and generating a second audio signal by rotating a phase of the first audio signal in one direction over time in conjunction with receipt of the sound.

### BRIEF DESCRIPTION OF THE DRAWINGS

FIG. 1 is a block diagram showing an example of a configuration of a sound processing system according to a first embodiment.

FIG. 2 is a block diagram showing an example of a functional configuration of the sound processing system.

FIG. 3 is an explanatory diagram of phase shifting.

FIG. 4 is a block diagram showing an example of a configuration of a sound processor.

FIG. 5 is a flowchart showing an example of phase shifting procedures.

FIG. 6 is a block diagram showing an example of a configuration of a sound processor according to a modification.

FIG. 7 is a diagram showing a sound processor according to a modification.

### DESCRIPTION OF THE EMBODIMENTS

### A: First Embodiment

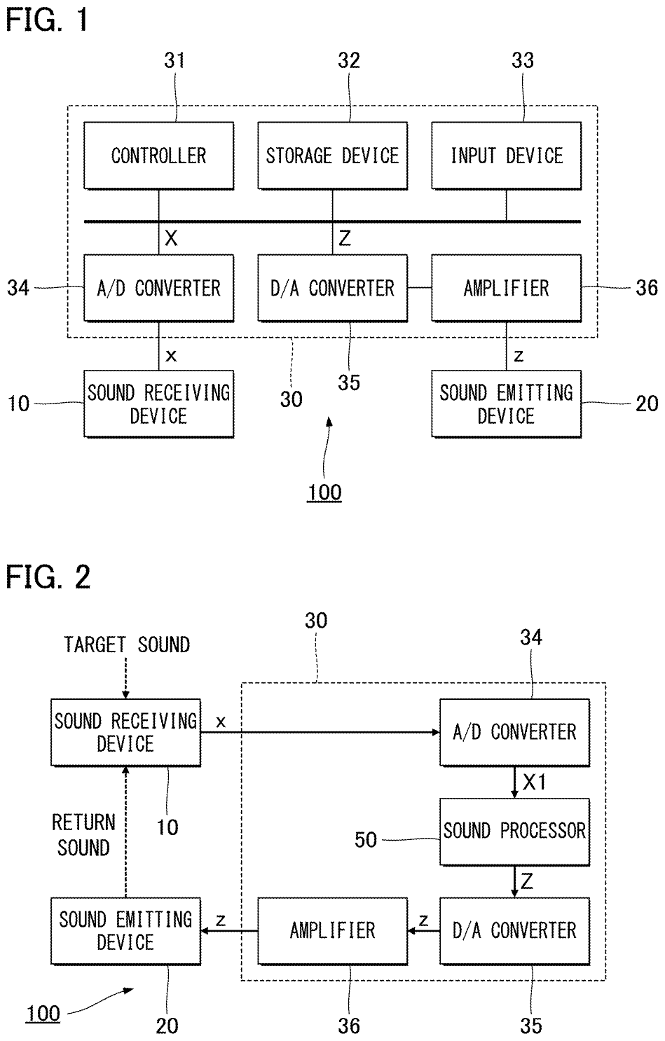

FIG. 1 is a block diagram showing an example of a configuration of a sound processing system 100 according to a first embodiment of this disclosure. The sound processing system 100 is a loudspeaker system that receives sound generated by a specific sound source (hereinafter, “target sound”), adjusts a volume of the target sound, and plays back the adjusted sound. The target sound may be a freely chosen sound, such as a voice sound or an instrumental sound. The sound processing system 100 includes a sound receiving device 10, a sound emitting device 20, and a signal processor 30.

The sound receiving device 10 is a microphone that receives sound in its vicinity and generates from the received sound an audio signal x. The audio signal x is a time-domain signal representative of a waveform of the sound received by the sound receiving device 10. The signal processor 30 generates an audio signal z from the audio signal x generated by the sound receiving device 10. The audio signal z is generated by the signal processor 30 in conjunction with the receipt of the sound by the sound receiving device 10. In one example, the sound emitting device 20 is a loudspeaker that plays back (emits) sound represented by the audio signal z generated by the signal processor 30. Communication between the signal processor 30 and the sound receiving device 10 may be either wired or wireless communication. Further, communication between the signal processor 30 and the sound emitting device 20 may be either wired or wireless communication. One or both of the sound receiving device 10 and the sound emitting device 20 may be included in the signal processor 30.

The sound receiving device 10 and the sound emitting device 20 are disposed in the same acoustic space (room). As a result, a part of the sound played back by the sound emitting device 20 (hereinafter, “playback sound”) reaches the sound receiving device 10 after being reflected by a wall of the acoustic apace. Consequently, the audio signal x includes two types of audio components: an audio component of the original target sound, and an audio component of a return sound received either directly or indirectly at the sound receiving device 10 from the sound emitting device 20 (hereinafter, “return sound”). In an audio closed loop in which return sound from the sound emitting device 20 to the sound receiving device 10 is present, howling occurs when the following states (i) and (ii) exist: (i) a gain of the entire audio system exceeds 1, and (ii) a phase corresponding to the component of the target sound is identical to or approximates that of the return sound. The signal processor 30, which is a howling suppression device that generates the audio signal z, suppresses howling by applying processing to the audio signal x.

The signal processor 30 includes a controller 31, a storage device 32, an input device 33, an A/D converter 34, a D/A converter 35, and an amplifier 36. The signal processor 30 may be a portable information device (e.g., a smartphone and a tablet), or may be a portable or stationary device such as a personal computer. The signal processor 30 may be a single device or may comprise more than one device.

The controller 31 is constituted of one or more processors that control components of the signal processor 30. Specifically, the controller 31 is constituted of one or more processors, such as a Central Processing Unit (CPU), a Sound Processing Unit (SPU), a Digital Signal Processor (DSP), a Field Programmable Gate Array (FPGA), or an Application Specific Integrated Circuit (ASIC).

The storage device 32 comprises at least one memory that stores a program executed by the controller 31, and a variety of types of data used by the controller 31. The storage device 32 may be constituted of a known recording medium, such as a magnetic recording medium or a semiconductor recording medium, or may be constituted of a combination of more than one type of recording media. Any recording medium, such as a portable recording medium that is attachable to or detachable from the signal processor 30, or an external recording medium (e.g., online storage) that is accessible by the signal processor 30, may be used as the storage device 32.

The input device 33 receives inputs from a user of the sound processing system 100. The input device 33 may include one or more input operators that are operable by the user, or may include a touch panel that detects a touch input of the user on a surface of a display (not shown).

The A/D converter 34 converts an analog audio signal x received by the sound receiving device 10 into a digital audio signal X1. The audio signal X1 is represented by a time-series of samples arranged on a time axis. The controller 31 generates a digital audio signal Z from the audio signal X1. The audio signal X1 is an example of a “first audio signal.”

The D/A converter 35 converts an audio signal Z into an analog audio signal z. The audio signal z is amplified by the amplifier 36. In one example, a gain of the amplifier 36 is set by the user by control of the input device 33. Upon receipt of the audio signal z amplified by the amplifier 36, the sound emitting device 20 plays back sound represented by the audio signal z. The digital audio signal Z may be amplified by the amplifier 36 (digital amplifier) provided before the D/A converter 35. The audio signal Z is an example of a “second audio signal.”

FIG. 2 is a block diagram showing an example of a functional configuration of the signal processor 30 (the sound processing system 100). The controller 31 executes a program stored in the storage device 32 to act as a sound processor 50. The sound processor 50 generates an audio signal Z by applying processing to the audio signal X1. Phase shifting, which is a type of processing implemented by the sound processor 50, is executed in conjunction with receipt of sound by the sound receiving device 10 and playback (emission) of sound by the sound emitting device 20.

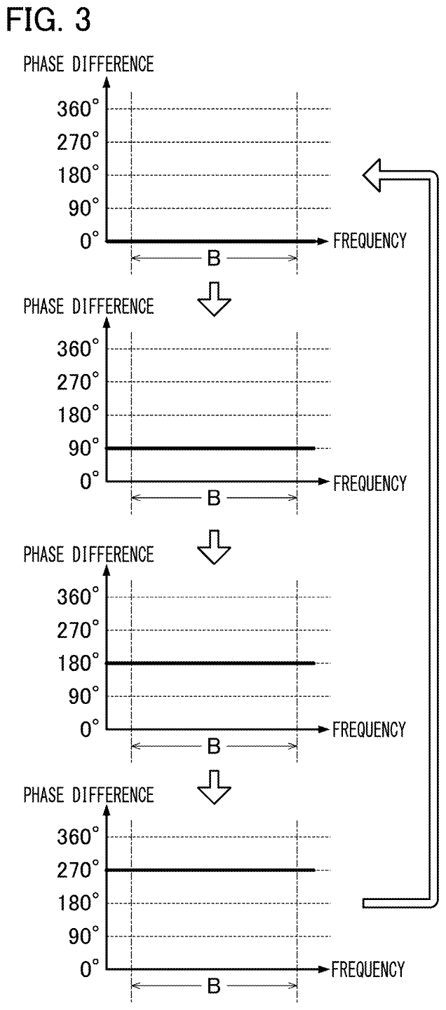

FIG. 3 is an explanatory diagram of phase shifting implemented by the sound processor 50. When the sound processor 50 implements phase shifting, a phase of the audio signal X1 is rotated in one direction over time to generate an audio signal Z. As a result, a phase difference of the audio signal Z relative to the audio signal X1 varies from moment to moment. The phase difference of the audio signal Z is the difference between the phase of the audio signal X1 and the phase of the audio signal Z. A processing cycle is repeated such that a phase difference of the audio signal Z relative to the audio signal X1 increases over time from 0° to 360°. The sound processor 50 provides the D/A converter 35 with the phase-shifted audio signal Z. Thus, in conjunction with receipt of sound by the sound receiving device 10, the sound processor 50 rotates the phase of the audio signal X1 in one direction over time to generate the audio signal Z. The sound processor 50 then causes the sound emitting device 20 to play back the sound represented by the audio signal Z.

The sound processing system 100 includes the audio closed loop, in which audio components (each of which include components of the target sound and the return sound) repeatedly circulate. Howling occurs in the audio closed loop when an amount of delay of the audio components is identical to or approximates an integer multiple of a period of the audio components. According to the first embodiment, even when conditions for howling exist, phases corresponding to the audio components circulating in the audio closed loop vary (shift), and as a result generation of standing waves is suppressed. The phase shifting adds a time-dependent phase between (i) the audio component of the target sound indicated by the audio signal X1, and (ii) the audio component of the return sound that would return in the same phase if no phase shifting were applied. According to the first embodiment, howling caused by the return sound can be suppressed without need for additional elements (processing), to identify a howling frequency. Further, according to the first embodiment, since the frequency of the audio signal X1 remains unchanged, howling can be suppressed without variations in audibly perceptible characteristics (e.g., pitches or sound qualities) of the playback sound.

As will be apparent from FIG. 3, the sound processor 50 according to the first embodiment rotates the phase of the audio signal X1 within over the entire frequency band at a constant rotational speed R. Specifically, the phase of the audio signal Z varies at the constant rotational speed R within the range of the audible band B from 20 Hz to 20 kHz.

The phase difference of the audio signal Z relative to the audio signal X1 remains constant over the entire frequency band, and thus the phase difference remains constant within the audible band B. By this configuration, a waveform (e.g., an envelope on the time-axis) of the audio signal Z remains substantially the same as that of the audio signal X1 without application of phase shifting. This is because a group delay remains stable between two audio signals: the audio signal X1 without application of phase shifting, and the phase-shifted audio signal Z. As a result, howling can be suppressed without causing variations in audibly perceptible characteristics (e.g., pitches or sound qualities) of the playback sound.

If the phase of the audio signal X1 is rotated at an excessively high speed, an audibly perceptible waveform distortion may occur in the waveform of the audio signal Z compared with the audio signal X1 to which phase shifting is applied. As a result of experiments carried out by the inventors, it was found that waveform distortion caused by rotation of phase shifting tends not to be perceivable when the rotational speed R of the phase is set at 2 rotations per second (720° per second) or less. Based on these findings, in the first embodiment, the rotational speed R of the phase set by the sound processor 50 is set at 2 rotations per second or less, and preferably at 1.5 rotations per second or less. By this configuration, howling is suppressed, and waveform distortion caused by phase rotation is also suppressed.

However, if the phase of the audio signal X1 is rotated at an excessively slow speed, variations in phases among waveforms of the audio components circulating in the audio closed loop are suppressed. Consequently, howling caused by the return sound may not be able to be effectively suppressed. As a result of experiments carried out by the inventors, it was found that howling tends to be effectively suppressed when the rotational speed R of the phase is set at 0.01 rotations per second (3.6° per second) or more. Based on these findings, in the first embodiment, the rotational speed R of the phase is set by the sound processor 50 at 0.01 rotations per second or more, and preferably at 0.1 rotations per second or more. By this configuration, howling caused by the return sound can be effectively suppressed.

As will be apparent from the foregoing description, in the first embodiment, the rotational speed R is set at 0.01 rotations per second or more and at 2 rotations per second or less. In other embodiments, the rotational speed R may be set at 0.1 rotations per second or more and at 1.5 rotations per second or less. Further in other embodiments, the rotational speed R may be set at 1 rotation per second (360° per second).

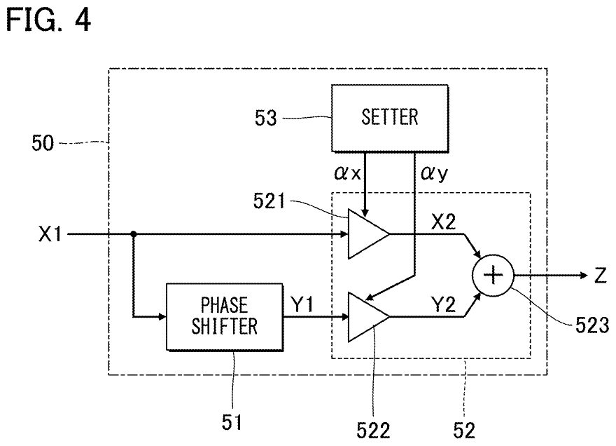

FIG. 4 is a block diagram showing an example of a configuration of the sound processor 50. The sound processor 50 according to the first embodiment includes a phase shifter 51, a synthesizer 52, and a setter 53. It is of note that the configuration of the sound processor 50 is not limited to the configuration shown in FIG. 4. An example is given below of the phase shifting in the time domain; however, the phase shifting may be in the frequency domain.

The phase shifter 51 applies processing to an audio signal X1 to generate an audio signal Y1 a phase of which differs from that of the audio signal X1. Specifically, the phase shifter 51 applies Hilbert transformation to the audio signal X1 to generate the audio signal Y1 a phase of which is delayed by 90° compared to that of the audio signal X1. The Hilbert transformation applied to the audio signal X1 is carried out by use of a FIR (Finite Impulse Response) filter. Two different-phase audio signals (X1, Y1) are supplied to the synthesizer 52. The audio signal Y1 is an example of a “third audio signal.”

The synthesizer 52 synthesizes the audio signal X1 and the audio signal Y1, more specifically, a weighted sum of the audio signals X1 and Y1, to generate the audio signal Z. In the first embodiment, the synthesizer 52 includes a multiplier (adjuster) 521, a multiplier (adjuster) 522, and an adder 523. The multiplier 521 multiplies the audio signal X1 by a weight ax to generate an audio signal X2. The multiplier 522 multiplies the audio signal Y1 by a weight αy, to generate an audio signal Y2. The adder 523 adds the audio signal X2 and the audio signal Y2, to generate the audio signal Z. Thus, the weights αx and αy are parameters that define a mix ratio of the audio signal X1 to the audio signal Y1. The audio signal X2 is an example of a “fourth audio signal,” and the audio signal Y2 is an example of a “fifth audio signal.”

The setter 53 controls the weight αx and the weight αy. Specifically, the setter 53 sets each of the weights αx and αy at −1 or more and at 1 or less. Appropriate setting of the mix ratio of the audio signal X1 to the audio signal Y1 (X1:Y1) enables the synthesizer 52 to generate the audio signal Z with a freely chosen phase difference relative to the audio signal X1.

In some embodiments, the weight αx may be set at 0 or more and at 1 or less, and the weight αy may be set at −1 or more and at 0 or less. These settings result in generation of an audio signal Z with a phase difference relative to the audio signal X1 of 0° or more and 90° or less.

In some embodiments, the weights αx and αy may each be set at −1 or more and at 0 or less. These settings result in generation of an audio signal Z with a phase difference that is 90° or more and 180° or less.

In some embodiments, the weight αx may be set at −1 or more and at 0 or less, and the weight αy may be set at 0 or more and at 1 or less. These settings result in generation of an audio signal Z with a phase difference that is 180° or more and 270° or less.

In some embodiments, the weights αx and αy may each be set at 0 or more and at 1 or less. These settings result in generation of an audio signal with a phase difference that is 270° or more and 360° or less. It is of note that the phase difference between the audio signals X1 and Y1 is not limited to 90°.

The setter 53 varies the weights αx and αy over time in conjunction with receipt of sound by the sound receiving device 10. The rotational speed R of the phase of the audio signal Z depends on a rate of change in each of the weights αx and αy. Specifically, the rotational speed R of the phase increases as the rate of change in each of weights αx and αy increases. In the first embodiment, the setter 53 varies the weights αx and αy over time such that the phase of the audio signal Z is rotated at a rotational speed R that sets at 0.01 rotations per second or more and at 2 rotations per second or less. Thus, control of the mix ratio of the audio signal X1 to the audio signal Y1 causes a change in the phase difference of the audio signal Z relative to the audio signal X1. As a result, according to the first embodiment, howling can be reduced by use of a simple configuration and application of uncomplicated processing.

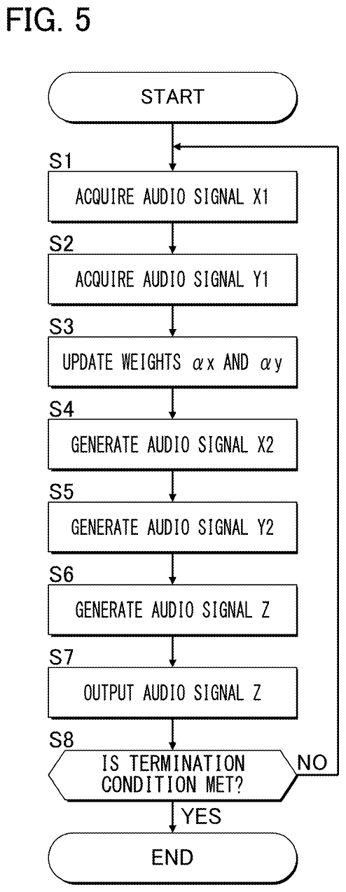

FIG. 5 is a flowchart showing an example of procedures of the phase shifting executed by the controller 31. For example, the phase shifting is started in response to a user input to the input device 33. The phase shifting continues in conjunction with receipt of sound by the sound receiving device 10.

Upon start of the phase shifting, the controller 31 acquires an audio signal X1 from the A/D converter 34 (S1). The controller 31 acts as a signal acquirer that acquires the audio signal X1. The controller 31 (the sound processor 50) generates an audio signal X from the audio signal X1 in accordance with the following procedures (S2 to S6).

The phase shifter 51 generates from the audio signal X1, an audio signal Y1 a phase of which differs from that of the audio signal X1 (S2). The setter 53 updates the weights αx and αy (S3). Specifically, the setter 53 varies the weights αx and αy by the amount of change set such that the rotational speed R of the phase of the audio signal Z reaches a target value (0.01≤R≤2). The multiplier 521 multiplies the audio signal X1 by the updated weight αx to generate an audio signal X2 (S4). The multiplier 522 multiplies the audio signal Y1 by the updated weight αy to generates an audio signal Y2 (S5). The synthesizer 52 adds the audio signals Y1 and Y2 to generate an audio signal Z (S6). The synthesizer 52 outputs the audio signal Z to the D/A converter 35 (S7).

The controller 31 determines whether a predetermined termination condition is met (S8). Examples of the termination condition include (i) receiving a termination instruction from the user who controls the input device 33, and (ii) supply of the audio signal X1 from the sound receiving device 10 stops. If the termination condition is not met (S8: NO), the controller 31 moves the processing to step S1. Thus, acquisition of the audio signal X1 (S1), generation of the audio signal Z (S2 to S6), and output of the audio signal Z (S7) are each repeated in conjunction with receipt of the sound by the sound receiving device 10. When the termination condition is met (S8: YES), the controller 31 terminates the phase shifting.

### B: Second Embodiment

A second embodiment will now be described. A second embodiment will now be described. In the first embodiment, the rotational speed R of the phase is set at a predetermined value. In contrast, in the second embodiment the rotational speed R is variable. In each configuration described below, the same reference signs are used to denote elements having functions identical to those in the first embodiment, and detailed explanations of such elements are omitted as appropriate.

The rotational speed R is determined by the user who controls the input device 33 to provide instructions to the signal processor 30. Specifically, the rotational speed R is adjusted by the user by controlling the input device 33 while listening to a playback sound from the sound emitting device 20. At this time, sound is received by the sound receiving device 10. The rotational speed R is adjusted such that there is no waveform distortion in the playback sound from the sound emitting device 20 and no howling.

The setter 53 receives user instructions for the rotational speed R. The setter 53 controls the rate of change for each of the weights αx and αy such that the phase of the audio signal Z is rotated at a rotational speed R determined by the user. The setter 53 may set the amount of change in the weights αx and αy at step S3 shown in FIG. 5 in accordance with the rotational speed R determined by the user.

The second embodiment provides the same effects as those provided by the first embodiment. Further, in the second embodiment, the rotational speed R of the phase of the audio signal Z is variable. As a result, howling can be effectively reduced in a variety of environments that have different acoustic characteristics, such as reflection characteristics.

### C: Modifications

Specific modifications applicable to each of the foregoing embodiments are set out below. More than one mode selected from the following descriptions may be combined, as appropriate, as long as such a combination does not give rise to any conflict.

### (1) First Modification

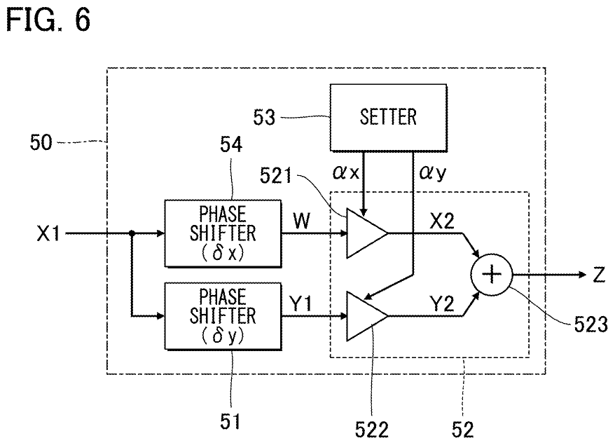

The configuration of the sound processor 50 is not limited to that shown in FIG. 4. The audio signal Z may be generated by the sound processor 50 shown in FIG. 6 from the audio signal X1. As shown in FIG. 6, the sound processor 50 includes a phase shifter 54 in addition to the same elements (a phase shifter 51, a synthesizer 52, and a setter 53) as those in the first embodiment.

The phase shifter 51 shown in FIG. 6 shifts (varies) the phase of the audio signal X1 to generate an audio signal Y1. The audio signal Y1 is obtained by shifting (e.g., delaying) the phase of the audio signal X1 by a predetermined amount δy. The audio signal Y1 is an example of a “third audio signal.”

The phase shifter 54 applies processing to the audio signal X1 to generate an intermediate signal W. The intermediate signal W is an audio signal obtained by shifting (e.g., delaying) the phase of the audio signal X1 by a predetermined amount δx. Specifically, an amount δx of shift applied by the phase shifter 54 is set such that a phase difference between the audio signal Y1 and the intermediate signal W is 90°. Also, an amount δy of shift applied by the phase shifter 51 is set such that a phase difference between the audio signal Y1 and the intermediate signal W is 90°. Thus, the phase shifter 54 shifts (varies) the phase of the audio signal X1 to generate the intermediate signal W with the predetermined phase difference relative to the audio signal Y1. It is of note that the amount δx of shift may be 0°, and the amount δy of shift may be 90°. This configuration is the same as that shown in FIG. 4.

The synthesizer 52 synthesizes the intermediate signal W and the audio signal Y1. More specifically, the synthesizer 52 obtains a weighted sum of the intermediate signal W and the audio signal Y1 to generate an audio signal Z. The synthesizer 52 includes a multiple (adjuster) 521, a multiple (adjuster) 522, and an adder 523. The multiplier 521 multiplies the intermediate signal W by the weight αx to generate an audio signal X2. The multiplier 522 multiplies the audio signal Y1 by the weight αy to generate an audio signal Y2. The adder 523 adds the audio signal X2 and the audio signal Y2 to generate an audio signal Z. Thus, the weights αx and αy are parameters that define a mix ratio of the intermediate signal W to the audio signal Y1. The audio signal X2 is an example of a “fourth audio signal”, and the audio signal Y2 is an example of a “fifth audio signal.”

Similar to the first embodiment, the setter 53 varies the weights αx and αy over time in conjunction with receipt of sound by the sound receiving device 10. Specifically, the setter 53 varies the weights αx and αy over time such that the phase of the audio signal Z is rotated at a rotational speed R set at 0.01 rotations per second or more and at 2 rotations per second or less. This modification provides the same effects as those provided by the first embodiment. Further, according to an example of FIG. 6, howling can be effectively suppressed by use of a simple configuration and application of uncomplicated processing to vary the weights αx and αy.

### (2) Second Modification

In the foregoing embodiments, an example is given in which the phase of the audio signal Z varies at a constant rotational speed R over the range of the audible band B. However, the rotational speed R may differ for each frequency on the frequency axis.

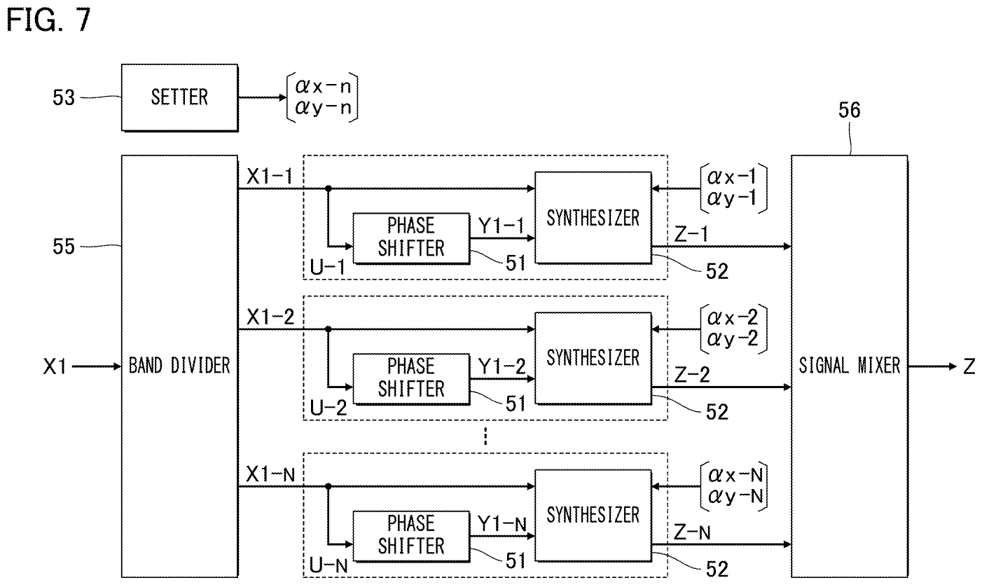

FIG. 7 is a diagram showing a sound processor 50A according to this modification. The sound processor 50 according to the foregoing embodiments is replaced with the sound processor 50A shown in FIG. 7. The sound processor 50A includes a band divider 55, N signal processors U-1 to U-N (N is a natural number of 2 or more), a signal mixer 56, and a setter 53.

The band divider 55 generates N band signals X1-1 to X1-N from an audio signal X1. Each band signal X1-n (n=1 to N) represents audio components within a frequency band B-n of the audio signal X1. The frequency band B-n refers to any of the N different frequency bands B-1 to B-N within the audible band B.

Similar to the sound processor 50 according to the foregoing embodiments, the signal processor U-n generates an audio signal Z-n using phase shifting by which a phase of the band signal X1-n is rotated in one direction over time. Specifically, the signal processor U-n includes (i) a phase shifter 51 that generates a band signal Y1-n from the band signal X-n, and (ii) a synthesizer 52 that obtains a weighted sum of the band signals X1-n and Y1-n to generate an audio signal Z-n. The synthesizer 52 of the signal processor U-n generates an audio signal Z1-n by adding: (i) the band signal X1-n weighted by the weight αx-n and (ii) the band signal Y1-n weighted by the weight αy-n. It is of note that the sound processor 50 shown in FIG. 6 may be employed as the signal processor U-n.

The setter 53 sets the weights αx-n and αy-n for each of the N signal processors U-1 to U-N. Specifically, the setter 53 varies the weights αx-n and ay-n over time such that the phase of each of the N audio signals Z-1 to Z-N is rotated at a different rotational speed R. The rotational speed R applied to the signal-processor U-n is set at 0.01 rotations per second or more and at 2 rotations per second or less.

The signal mixer 56 mixes (e.g., adds) the N audio signals Z-1 to Z-N generated by the different signal processors U-n to generate the audio signal Z. According to an example configuration of FIG. 7, by setting a different rotational speed R for each audio signal Z-n, particularly effective suppression howling is achieved.

In the second modification shown in FIG. 7, the rotational speed R differs for each frequency band B-n. However, in some cases, the second modification may involve the disadvantages described below. First, the configuration and processing of the sound processor 50 may be more complex than those according to the foregoing embodiments, in which the rotational speed R remains constant over the range of the audible band B. Second, degradation in a quality of sound output from the sound emitting device 20 may occur. This is because a phase difference becomes discontinuous in the vicinity of the boundary between two frequency bands B-n adjacent to each other on the frequency domain. In contrast, in the foregoing embodiments the phase difference remains constant over the range of the audible band B, and the rotational speed R also remains constant. As a result, degradation in a quality of audible sound that may otherwise result from a discontinuity in phase difference is avoided.

### (3) Third Modification

In the foregoing embodiments, the audio signal Z is generated by rotating the phase of the audio signal X1 in one direction. However, the direction in which the phase of the audio signal X1 is rotated is not limited to a particular direction (e.g., a direction in which the phase increases). The sound processor 50 may generate the audio signal Z by (i) increasing the phase of the audio signal X1 in a first period on the time axis and (ii) decreasing the phase of the audio signal X1 in a second period that differs from the first period. Further, the phase of the audio signal X1 need not be rotated by one turn, and may be reciprocated within a predetermined range.

### (4) Fourth Modification

In the foregoing embodiments, the phase of the audio signal X1 is rotated over the range of the audible band B. However, a configuration can be envisaged in which the phase is not rotated in a particular frequency band. The phase may not be rotated in a frequency band in which a probability of howling occurrence is relatively low.

For example, the fourth modification may be combined with the second modification shown in FIG. 7. In this combination, the N signal processors U-1 to U-N includes a signal processor U-n that corresponds to a frequency band B-n in which the probability of an occurrence of howling is relatively low within the audible band B. The signal processor U-n does not execute the phase shifting. This signal processor U-n outputs, as an audio signal Z-n, an audio signal X1-n with no application of processing. According to such a configuration, the phase shifting is executed only for the frequency band B-n that involves howling. As a result, a waveform distortion of the playback sound can be reduced as compared with a case in which the phase of the audio signal X1 is rotated over the entire part within the audible band B.

### (5) Modification 5

In the foregoing embodiments, a rotation of a phase is maintained. However, the rotation of the phase of an audio signal X1 may be applied in a limited manner within a certain period on the time axis (hereinafter, “processing period”). The audio signal X1 may be output from the sound processor 50 as the audio signal Z in a period other than the processing period.

### (6) Modification 6

The signal processor 30 may be a server apparatus that communicates with an information device, such as a smartphone or a tablet. In this case, the audio signal X1 representative of sound received by the sound receiving device 10 is transmitted from the terminal device to the information device. The sound processor 50 of the signal processor 30 generate an audio signal Z based on the audio signal X1 using the same phase shifting similar to the foregoing embodiments and transmits the audio signal Z to the information device. The information device plays back sound represented by the audio signal Z received from the signal processor 30. Such a configuration provides the same effects as those provided by the foregoing embodiments.

### (7) Modification 7

The functions of the signal processor 30 (the sound processor 50) according to the foregoing embodiments are implemented by cooperation of one or more processors, which comprises the controller 31, and a program stored in the storage device 32. The program according to this disclosure may be provided by being pre-recorded on a computer-readable recording medium, and may be installed in a computer. The computer-readable recording medium may be a non-transitory recording medium, examples of which include an optical recording medium (optical disk), such as a CD-ROM. The computer-readable recording medium may be a known recording medium, such as a semiconductor recording medium, or a magnetic recording medium. The non-transitory recording medium includes any recording medium excluding a transitory propagating signal, and a volatile recording medium is not excluded. When programs are distributed by a distribution device via a network, a storage device included in the distribution device corresponds to a non-transient recording medium described above.

### D: Appendices

The following configurations are derivable from the foregoing embodiments.

A computer-implemented sound processing method according to one aspect (Aspect 1) of this disclosure includes acquiring a first audio signal representative of sound received by a sound receiving device; and generating a second audio signal by rotating a phase of the first audio signal in one direction over time in conjunction with receipt of the sound.

According to this aspect, the second audio signal is generated by rotating, in one direction over time, the phase of the first audio signal representative of the sound received by the sound receiving device. That is, the phase varies (shifts) between audio components that repeatedly circulate in an audio closed loop, which includes a sound emitting device as well as the sound receiving device that receives return sound from the sound emitting device. This aspect requires no additional elements (processing) to identify a howling frequency and suppress howling caused by the return sound. Further, in this aspect since the frequency of the audio signal remains unchanged, no variations occur in audibly perceptible characteristics (e.g., pitches or sound quality) of the playback sound in suppressing howling.

A freely chosen requirement can be provided for rotating the phase of the first audio signal. The phase may rotate in a direction in which the phase increases or decreases. The rotational speed of the phase may be constant or may be variable. The phase of the second audio signal may vary stepwise or continuously (e.g., linear or curvilinear).

The phase of the second audio signal need not be rotated under the same conditions over the range of the audible band on the frequency axis (in a frequency spectrum). It is envisaged that the phase of the first audio signal is rotated at the same phase difference within the audible band (see, Aspect 6), or the phase differs for each frequency band on the frequency axis. It is also envisaged that the phase of the first audio signal is rotated at the same speed within the audible band (see, Aspect 5), or the phase is rotated at a different speed for each frequency band on the frequency axis.

In an example (Aspect 2) according to Aspect 1, the sound processing method includes playing back, by a sound emitting device, sound represented by the second audio signal.

Since a part of the sound represented by the second audio signal output from the sound emitting device returns to the sound receiving device, howling is likely to occur. However, even in this aspect, howling can be effectively suppressed.

In an example (Aspect 3) according to Aspect 1 or 2, the sound processing method includes rotating the phase of the first audio signal at a rotational speed of 2 rotations per second or less.

If the phase of the first audio signal rotates at an excessively high speed, an audibly noticeable waveform distortion may occur in the first audio signal. In this aspect, in which the rotational speed of the phase is set at 2 rotations per second (720° per second) or less, howling can be suppressed while also suppressing occurrence of the waveform distortion caused by the rotation of the phase.

In an example (Aspect 4) according to any one of Aspects 1 to 3, the sound processing method includes rotating the phase of the first audio signal at a rotational speed of 0.01 rotations per second or more.

If the phase of the first audio signal rotates at an excessively slow speed, suppression of howling may not be effective. In this aspect, in which the rotational speed of the phase is set at 0.01 rotations per second (3.6° per second) or more, suppression of howling is effective.

In an example (Aspect 5) according to any one of Aspects 1 to 4, generating the second audio signal includes (i) generating a third audio signal by varying the phase of the first audio signal, (ii) generating the second audio signal by adding: a fourth audio signal generated by multiplying the first audio signal by a first weight, and a fifth audio signal generated by multiplying the third audio signal by a second weight; and (iii) rotating the phase of the first audio signal by varying the first and second weights over time.

According to this aspect, howling can be effectively suppressed by use of a simple configuration and application of uncomplicated processing for varying the first and second weights.

In an example (Aspect 6) according to any one of Aspects 1 to 4, generating the second audio signal includes (i) generating a third audio signal by varying the phase of the first audio signal, (ii) generating an intermediate signal with a predetermined phase difference relative to the third audio signal by varying the phase of the first audio signal, (iii) generating the second audio signal by adding the following into one another: a fourth audio signal generated by multiplying the intermediate signal by a first weight, and a fifth audio signal generated by multiplying the third audio signal by a second weight; and (iv) rotating the phase of the first audio signal by varying the first and second weights over time.

According to this aspect, howling can be effectively suppressed by use of a simple configuration and application of uncomplicated processing for varying the first and second weights.

In an example (Aspect 7) according to any one of Aspects 1 to 6, generating the second audio signal includes rotating the phase of the first audio signal at a constant speed within an audible band.

In this aspect, the phase of the first audio signal is rotated at a constant speed within the audible band. As a result, processing and configuration are simpler those that in which the phase is rotated at a different speed for each frequency band on the frequency axis. It is of note that the audible band is 20 Hz or more and 20 kHz or less.

In an example (Aspect 8) according to Aspect 7, a phase difference of the second audio signal relative to the first audio signal remains constant within the audible band.

In this aspect, a waveform (e.g., an envelope) of an audio signal to which the processing is applied remains substantially the same as that of an audio signal to which processing is applied. This is because a group delay remains stable between an audio signal with no rotation and an audio signal with rotation. As a result, howling can be suppressed without variations in audibly perceptible characteristics (e.g., pitches or sound qualities) of the playback sound.

In an example (Aspect 9) according to any one of Aspects 1 to 4, generating the second audio signal includes (i) generating, from the first audio signal, a plurality of band signals, a frequency band of each of which differs from one another, (ii) rotating each of the plurality of band signals at a different rotational speed, and (iii) generating the second audio signal by mixing the plurality of rotated band signals.

According to this aspect, howling can be more effectively suppressed than a case in which a rotation angle remains constant over the entire band within the audible band because the rotation angle differs for each frequency band.

In an example according to any one of Aspects 1 to 9, generating the second audio signal includes (i) generating a third audio signal by varying a phase of the first audio signal, (ii) generating the second audio signal by mixing the first and third audio signals, and (iii) rotating the phase of the first audio signal by varying a mixing ratio of the first audio signal to the third audio signal.

In this aspect, the phase of the second audio signal can be rotated by use of a simple configuration and application of uncomplicated processing for varying the mix ratio of the first audio signal to the third audio signal.

A sound processing system according to one aspect (Aspect 10) of this disclosure includes at least one memory configured to store instructions; and at least one processor configured to implement the instructions to (i) acquire a first audio signal representative of sound received by a sound receiving device, and (ii) generate a second audio signal by rotating a phase of the first audio signal in one direction over time in conjunction with receipt of the sound.

In an example (Aspect 11) according to Aspect 10, the at least one processor is configured to implement the instructions to: cause a sound emitting device to play back sound represented by the second audio signal.

In an example (Aspect 12) according to Aspect 10 or 11, the at least one processor is configured to implement the instructions to: rotate the phase of the first audio signal at a rotational speed of 2 rotations per second or less.

In an example (Aspect 13) according to any one of Aspects 10 to 12, the at least one processor is configured to implement the instructions to: rotate the phase of the first audio signal at a rotational speed of 0.01 rotations per second or more.

In an example (Aspect 14) according to any one of Aspects 10 to 13, the at least one processor is configured to implement the instructions to: generate the second audio signal by: generating a third audio signal by varying the phase of the first audio signal; generating the second audio signal by adding: a fourth audio signal generated by multiplying the first audio signal by a first weight, and a fifth audio signal generated by multiplying the third audio signal by a second weight; and rotating the phase of the first audio signal by varying the first and second weights over time.

In an example (Aspect 15) according to any one of Aspects 10 to 13, the at least one processor is configured to implement the instructions to: generate the second audio signal by: generating a third audio signal by varying the phase of the first audio signal; generating an intermediate signal with a predetermined phase difference relative to the third audio signal by varying the phase of the first audio signal; generating the second audio signal by adding: a fourth audio signal generated by multiplying the intermediate signal by a first weight, and a fifth audio signal generated by multiplying the third audio signal by a second weight; and rotating the phase of the first audio signal by varying the first and second weights over time.

In an example (Aspect 16) according to any one of Aspects 10 to 15, the at least one processor is configured to implement the instructions to: generate the second audio signal by: rotating the phase of the first audio signal at a constant speed within an audible band.

In an example (Aspect 17) according to Aspect 16, a phase difference of the second audio signal relative to the first audio signal remains constant within the audible band.

In an example (Aspect 18) according to any one of Aspects 10 to 13, the at least one processor is configured to implement the instructions to: generate the second audio signal by: generating, from the first audio signal, a plurality of band signals, a frequency band of each of which differs from one another; rotating each of the plurality of band signals at a different rotational speed; and generating the second audio signal by mixing the plurality of rotated band signals.

A recording medium according to one aspect (Aspect 19) of this disclosure is a non-transitory computer-readable recording medium storing instructions executable to perform operations including (i) acquiring a first audio signal representative of sound received by a sound receiving device, and (ii) generating a second audio signal by rotating a phase of the first audio signal in one direction over time in conjunction with receipt of the sound.

### DESCRIPTION OF REFERENCES SIGNS

100 . . . sound processing system, 10 . . . sound receiving device, 20 . . . sound emitting device, 30 . . . signal processor, 31 . . . controller, 32 . . . storage device, 33 . . . input device, 34 . . . A/D converter, 35 . . . D/A converter, 36 . . . amplifier, 50 . . . sound processor, 51 . . . phase shifter, 52 . . . synthesizer, 521 . . . multiplier, 522 . . . multiplier, 523 . . . adder, 53 . . . setter, 55 . . . band divider, 56 . . . signal mixer, and U-1 to U-N . . . signal processors.

What is claimed is:

1. A computer-implemented sound processing method comprising:
acquiring a first audio signal representative of sound received by a sound receiving device; and
generating a second audio signal by rotating a phase of the first audio signal in one direction over time in conjunction with receipt of the sound.

2. The computer-implemented sound processing method according to claim 1, comprising playing back, by a sound emitting device, sound represented by the second audio signal.

3. The computer-implemented sound processing method according to claim 1, comprising: rotating the phase of the first audio signal at a rotational speed of 2 rotations per second or less.

4. The computer-implemented sound processing method according to claim 1, comprising: rotating the phase of the first audio signal at a rotational speed of 0.01 rotations per second or more.

5. The computer-implemented sound processing method according to claim 1, wherein generating the second audio signal comprises:
generating a third audio signal by varying the phase of the first audio signal;
generating the second audio signal by adding:
a fourth audio signal generated by multiplying the first audio signal by a first weight, and
a fifth audio signal generated by multiplying the third audio signal by a second weight; and
rotating the phase of the first audio signal by varying the first and second weights over time.

6. The computer-implemented sound processing method according to claim 1, wherein generating the second audio signal comprises:
generating a third audio signal by varying the phase of the first audio signal;
generating an intermediate signal with a predetermined phase difference relative to the third audio signal by varying the phase of the first audio signal;
generating the second audio signal by adding:
a fourth audio signal generated by multiplying the intermediate signal by a first weight, and
a fifth audio signal generated by multiplying the third audio signal by a second weight; and
rotating the phase of the first audio signal by varying the first and second weights over time.

7. The computer-implemented sound processing method according to claim 1, wherein generating the second audio signal comprises rotating the phase of the first audio signal at a constant speed within an audible band.

8. The computer-implemented sound processing method according to claim 7, wherein a phase difference of the second audio signal relative to the first audio signal remains constant within the audible band.

9. The computer-implemented sound processing method according to claim 1, wherein generating the second audio signal comprises:
generating, from the first audio signal, a plurality of band signals, a frequency band of each of which differs from one another;
rotating each of the plurality of band signals at a different rotational speed; and
generating the second audio signal by mixing the plurality of rotated band signals.

10. A sound processing system comprising:
at least one memory configured to store instructions; and
at least one processor configured to implement the instructions to:
acquire a first audio signal representative of sound received by a sound receiving device; and
generate a second audio signal by rotating a phase of the first audio signal in one direction over time in conjunction with receipt of the sound.

11. The sound processing system according to claim 10, wherein the at least one processor is configured to implement the instructions to:
cause a sound emitting device to play back sound represented by the second audio signal.

12. The sound processing system according to claim 10, wherein the at least one processor is configured to implement the instructions to:
rotate the phase of the first audio signal at a rotational speed of 2 rotations per second or less.

13. The sound processing system according to claim 10, wherein the at least one processor is configured to implement the instructions to:
rotate the phase of the first audio signal at a rotational speed of 0.01 rotations per second or more.

14. The sound processing system according to claim 10, wherein the at least one processor is configured to implement the instructions to:
generate the second audio signal by:
generating a third audio signal by varying the phase of the first audio signal;
generating the second audio signal by adding:
a fourth audio signal generated by multiplying the first audio signal by a first weight, and
a fifth audio signal generated by multiplying the third audio signal by a second weight; and
rotating the phase of the first audio signal by varying the first and second weights over time.

15. The sound processing system according to claim 10, wherein the at least one processor is configured to implement the instructions to:
generate the second audio signal by:
generating a third audio signal by varying the phase of the first audio signal;
generating an intermediate signal with a predetermined phase difference relative to the third audio signal by varying the phase of the first audio signal;
generating the second audio signal by adding:
a fourth audio signal generated by multiplying the intermediate signal by a first weight, and
a fifth audio signal generated by multiplying the third audio signal by a second weight; and
rotating the phase of the first audio signal by varying the first and second weights over time.

16. The sound processing system according to claim 10, wherein the at least one processor is configured to implement the instructions to:
generate the second audio signal by:
rotating the phase of the first audio signal at a constant speed within an audible band.

17. The sound processing system according to claim 16, wherein a phase difference of the second audio signal relative to the first audio signal remains constant within the audible band.

18. The sound processing system according to claim 10, wherein the at least one processor is configured to implement the instructions to:
generate the second audio signal by:
generating, from the first audio signal, a plurality of band signals, a frequency band of each of which differs from one another;
rotating each of the plurality of band signals at a different rotational speed; and
generating the second audio signal by mixing the plurality of rotated band signals.

19. A non-transitory computer-readable recording medium storing instructions executable to perform operations comprising:
acquiring a first audio signal representative of sound received by a sound receiving device; and
generating a second audio signal by rotating a phase of the first audio signal in one direction over time in conjunction with receipt of the sound.
